(19) United States
(12) Patent Application Publication
(10) Pub. No.: US 2011/0278025 A1
(43) Pub. Date: Nov. 17, 2011

(54) Template Device and Method for Trimming Equine Animal Hooves

(76) Inventor: Gerald W. Hamilton, Winnipeg (CA)

(21) Appl. No.: 12/777,403

(22) Filed: May 11, 2010

(51) Int. Cl. A01L 11/00

(52) U.S. Cl. 168/48.1; 33/195

(57) ABSTRACT

Unbalanced feet are known to cause lameness in horses. A trimming template, when attached securely around the exterior hoof wall with predetermined and precise measurements, will guide the farrier's hoof-cutting tools to trim the foot into perfect balance. This device looks like an oversized flat horseshoe with a hinge about half way between the toe and the heel on each side, allowing both heels to swing out or in. On the inside, protruding nail-type pins will penetrate into the hoof wall when the device is closed therearound between the coronary band and the foot's ground surface. Attached to one heel is an expanding strap that snaps onto the other heel to hold the device in place. Tool hardened steel construction withstands wear and tear. This device encircles the hoof wall, then locks solidly into place and stays attached to the foot to guide farrier tools for quick and accurate trimming.

### FIELD OF THE INVENTION

This invention relates to the correct hoof trimming of the equine foot, and more particularly, to an Equine Trimming Template device that facilitates this task by a farrier, making his job easier, faster and more accurate.

### BACKGROUND OF THE INVENTION

There are many factors that relate to trimming a horse's foot into perfect balance correctly, and until now, only a very experienced and highly skilled farrier has been able to consistently accomplish this technical task by eye alone.

“To balance the foot and leg is, therefore, the first and most important step in the shoeing process.” So said William Russell in his 1903 edition of Scientific Horseshoeing. The same can still be said today.

Horse feet that are kept balanced are seldom lame. It is a well established fact amongst farriers. veterinarians, trainers and other horse professionals, that the majority of foot and leg diseases are caused or aggravated by unbalanced feet.

In 1987, the Journal of the American Veterinary Medical Association reported that America horse owners lose $500 million dollars to lameness-related problems every year. However, in 2010, that number could easily be double.

Every horse needs to be in balance, as far as his feet are concerned, the feet are the foundation of the horse. Whether you have a working horse or a pleasure horse, the feet must be balanced in order for that horse to give you 100%.

When a trimming mistake is made and a horse is put out of balance because too much hoof wall was removed, there is nothing that can be done to correct this mistake for several weeks, until the hoof grows back.

When a horse carries a rider over jumps, or at high speed, the pressure of the load on the foot when it hits the ground with each stride, causes extreme stress and strain on the back, spine, leg muscles, joints and tendons that will quickly breakdown into severe pain and soreness, followed by lameness if the foot is not landing flat, level, and in total balance each time it hits the ground.

Perfect balance requires careful measurement and control over three measurements of the hoof:

1. length of toe (measurement from the coronary band at the center of the foot, down to ground surface);
2. angle of toe (angle of toe hoof wall in relation to ground surface front to back of hoof);
3. length of heels (measurement at both heels from coronary band to ground surface).

If one heel is shorter than the other one, the foot will be out of balance side to side.

If the toe length is correct, but the heels are incorrect by being too short, this automatically makes the toe angle incorrect also. This foot is out of balance front to back and is impossible to fix until the heels grow back.

If the length of heels is correct, but the length of toe is incorrect by being too short, then this automatically makes the angle of the toe incorrect also. This foot is out of balance front to back and is impossible to fix until the toe grows back.

Trying to fix such problems by trimming more off the tough hard sole of the foot, will make the sole thinner and thereby very sensitive and subject to stone bruising, soreness and lameness. Trimming even more off the sole, will make it so thin that it will be as soft and flexible as a paper napkin, just before the blood starts to flow out of it, causing immediate lameness.

If only one out of four feet is out of balance, this horse will be sore, lame, and unusable for the next several weeks. This is very costly and upsetting to the horse owner.

All of these out of balance examples were totally preventable with proper hoof trimming, which is aided through use of this invention—Equine Trimming Template.

In an article by David Farmilo, Accredited Master farrier, of Oakbank, South Australia, written in 2004 he said . . . “I have been shoeing horses for 50 years this year, and I estimate that in my career I have shod or trimmed well over 100,000 horses. Sadly, I find that 90% of lameness in horses is hoof related, and this is totally unnecessary. Most gait and back strain problems stem from incorrect trimming and shoeing that should have been corrected simply by balancing the hoof.

By just “eye-balling the horse's foot”, it will be only the very, very experienced farrier that can trim a hoof into perfect balance every time.

Criteria of a perfectly balanced equine hoof when placed on a level horizontal ground surface must have the following: #1. a specific length of toe and side walls between the coronary band and the ground surface; #2 a specific angle of toe wall in relation to ground surface; and #3. the ground bearing surface of the hoof wall must be level side to side and front to back.

Even though all farriers know the criteria of a balanced hoof, and even though all farriers have access to many types of hoof gauges that show them how much to trim off, there is nothing but their eyes to stop their very sharp trimming tools from cutting too much hoof off unevenly. This mishap is the biggest and most common mistake made, and is the leading cause of lameness.

Thus, there is a need for a device to address this problem, the elimination of which would bring the biggest benefit of all by relieving future lameness, pain and suffering of the equine animal.

That is, new solutions are needed for working toward the desirable ability to trim all horses feet into perfect balance, and thereby eliminate the serious problems caused by horses feet that are not trimmed into proper balance.

### SUMMARY OF THE INVENTION

According to a first aspect of the invention there is provided a template device for use in trimming an animal hoof, the device comprising a series of links hingedly connected end to end by pivotal connections about parallel axes, two end links in the series having free ends opposite the pivotal connections of the two end links to one or more other links therebetween, the free ends of the end links defining opposite ends of the series of links, the series of links being pivotal relative to one another into and out of a horseshoe-shaped configuration in which corresponding side edges of the series of links are positioned end-to-end along a curved path to enable positioning of the links about the animal hoof, bottom surfaces of the series of links lying in a same common plane to form a guide for trimming of the bottom of the hoof when the series of links is held stationary against the hoof.

Preferably the corresponding side edges of the series of links are curved concavely therealong.

Preferably there are provided hoof engagement elements at the corresponding side edges to grip the animal hoof when placed thereagainst.

Preferably each hoof engagement element comprises a pointed end pointing away from a remainder of a corresponding link on which the hoof engagement element is carried.

Preferably the hoof engagement elements comprise pins projecting from the corresponding sides of the series of links at spaced positions along the series of links.

Preferably there is provided a fastener operable to secure the series of links in place on the hoof of the animal.

The fastener may be operable to interconnect the end links to form a closure of the series of links around the animal hoof.

The fastener may be operable to interconnect the ends links with varying distances between the free ends of the end links corresponding to varying sizes of the horseshoe-shaped configuration.

The fastener may comprise a strap fixed to a first of the two end links proximate a first end of the strap.

The strap preferably comprises a series of attachment points spaced therealong proximate a second end of the strap opposite the first, each attachment point being selectively and removably engageable to a retaining point carried on a second of the two end links.

There may be provided a hoof gauge carried on a respective link of the series of links, the hoof gauge comprising a measuring arm pivotal relative to the respective link about an axis extending therealong parallel to the common plane and at least one indicator arranged to convey at least one, but preferably both, of an angle at which the measuring arm is disposed relative to the common plane and a length from proximate common plane to different positions along the measuring arm.

Preferably there is provided a locking mechanism arranged to selectively lock an angular position of the measure arm about the axis.

Preferably the at least one indicator comprises a length indicator featuring a series of distance markings spaced along the measuring arm and a slide unit displaceable along the measuring arm and releaseably lockable at any selected position therealong indicating a respective one of the distance markings.

Preferably the series of links comprises a central link that is concavely curved along the corresponding side thereof, the concavely curved corresponding side spanning approximately 180 degrees.

The series of links may consist of the central link and the two end links.

Alternatively, the series of links may comprises the central link, the two end links and two intermediate links each disposed between the central link and a respective one of the two end links.

According to a second aspect of the invention there is provided a template device for use in trimming an animal hoof, the device comprising:

a central link having top and bottom surfaces facing opposite directions and a concave inner edge interconnecting the top and bottom surfaces along curved inner sides thereof to enable placement of the central link adjacent the front of the animal hoof in a position curving thereabout to extend rearwardly about the animal hoof on opposite sides thereof;

first and second extension links having hinged connections to central link adjacent respective opposing ends of the concave inner edge to facilitate pivoting of the first and second extension links about parallel axes that extend in directions passing through the top and bottom surface of the central link, the extension links being pivotal toward and away from one another and the concave inner edge of the central link to adjust a distance between ends of the extension links opposite the central link to accommodate differently sized hooves between the extension links during the placement of the central link thereon, and

hoof engagement elements provided at the concave inner edge of the central link to grip the front of the animal hoof when placed thereagainst to resist movement relative thereto;

the extension links having respective lower surfaces lying in a same common plane as the bottom surface of the central link to effectively provide extensions thereof past the respective end of the concave inner edge of the central link, the bottom surface and the extensions thereof providing a guide for trimming of the animal hoof along the common plane in which the bottom surface and the extensions thereof lie when the device is held in place against the animal hoof with central link curving from the front thereof and the extension links closed toward one another rearwardly around the hoof from the central link.

According to a third aspect of the invention there is provided a method of trimming a hoof of an animal comprising:

temporarily securing a template device, having guide surfaces disposed within a common plane of the device, to the hoof in a position extending about the periphery of the hoof with the guide surfaces positioned adjacent the hoof in a trimming plane corresponding to a selected combination of toe length, toe angle and heel length;

with the template device secured to the hoof, trimming away hoof wall material from a bottom of the hoof up to the common plane in which the guiding surfaces lie to produce a resulting flat bottom of the hoof wall that occupies the trimming plane; and

removing the template device from the hoof.

Preferably template device is temporarily secured to the hoof while the hoof is standing on a surface that is not any part of the template device.

Preferably the template device is temporarily secured to the hoof while the hoof is standing on ground.

The method may comprise first marking a periphery of the hoof with a toe marking proximate a front of the hoof and heel markings proximate a rear of the hoof on opposite sides thereof; then temporarily securing the template device to the hoof with the guide surfaces aligned with the toe and heel markings on the hoof.

Alternatively, the method may comprise first using a hoof gauge on the device to measure out the toe length and toe angle of the selected combination on the hoof, and then securing the device to the hoof in a position at which the hoof gauge measures out said toe length and toe angle and the guide surfaces are accordingly positioned in the trimming plane.

### BRIEF DESCRIPTION OF THE DRAWINGS

In the accompanying drawings, which illustrate a exemplary embodiments of the present invention:

FIG. 1 is a top view of this device showing it in the closed position, with the high tension heel strap fastened in place.

FIG. 2 is a top view of this device showing it in the open position, without the heel strap.

FIG. 3 is a side view of this device showing it attached firmly to an equine foot in the locked and ready position to trim-off the excess hoof wall.

FIG. 4 is a side view of an alternate embodiment of this device with a gauge, showing it attached firmly to an equine foot in the locked and ready position to trim-off the excess hoof wall.

### DETAILED DESCRIPTION

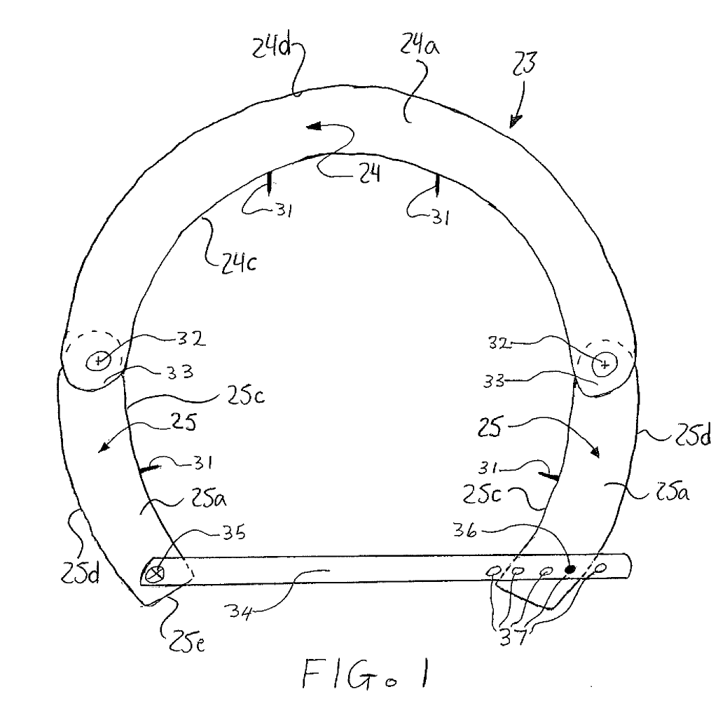

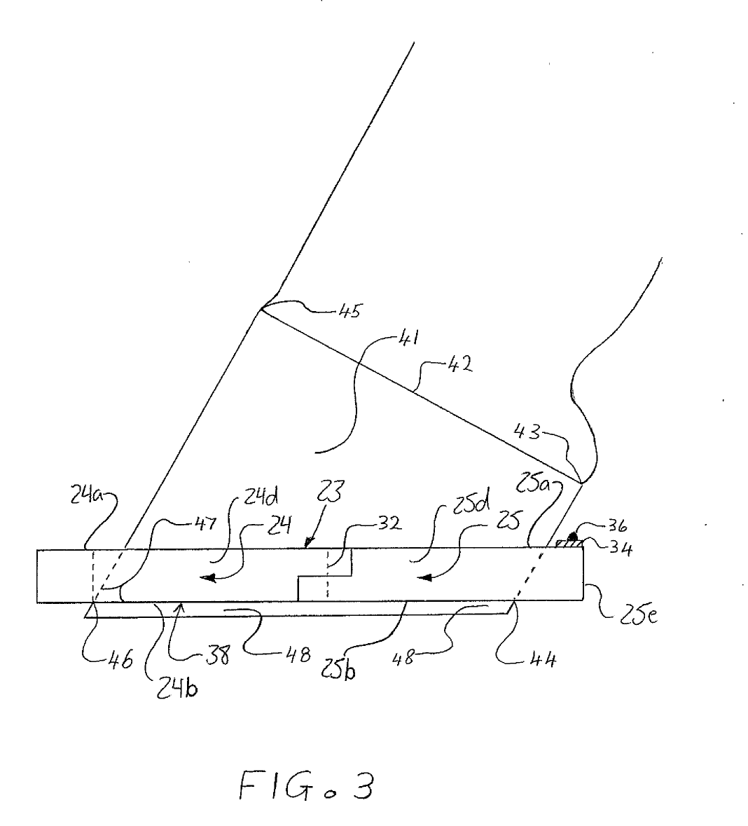

FIG. 1 is a drawing of a first embodiment or basic version of the device 23 in a closed and locked position. Except for a high tension heel strap 34 the device 23 is made of high quality tool hardened steel thereby making this device 23 very durable. Steel holding pins 31 penetrate the horse's foot/hoof wall 41 when this device 23 is attached (FIGS. 3 & 4) to the horse's foot 41. These holding pins 31 penetrate into the hoof 41 about a quarter of an inch on average. (depending on the size of the foot 41). The holding pins 31 contribute greatly to holding the device 23 firmly in place when attached (FIGS. 3 & 4) to the horse's foot 41. The penetration of the holding pins 31 into the horse's hoof wall 41 are very close to ground surface (FIGS. 3&4) where the hoof wall 41 is thick enough and insensitive enough that the horse feels no discomfort. The small holes left in the hoof wall 41 by the penetrating holding pins 31 are much less damaging to the hoof wall 41 than horseshoeing nails.

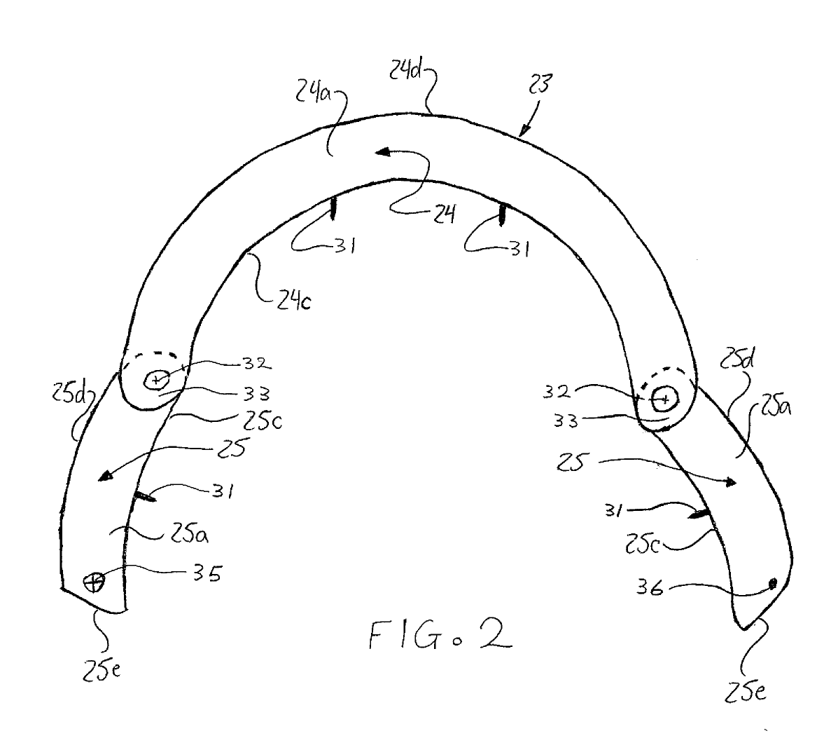

The device 23 has two pivot hinges 33 that allow the device 23 to open up (FIG. 2) to encircle the horse's foot 41, as seen in FIGS. 3 & 4. In the case of large horses, such as draft horses, the device 23 would be much larger and could have more holding pins 31, and more pivot hinges 33 than shown in FIGS. 1-4. The high tension heel strap 34 is anchored 35 on one heel of the device 23, and is pulled and stretched firmly across the back of the horses foot 41 to have one of several tension-adjustment hole settings 37 pulled tight over a strap holding pin 36 located on the other heel of the device 23, thereby holding the device 23 firmly attached to the horse's foot 41 in conjunction with the penetrating holding pins 31.

Also shown in FIG. 1 are the center axes 32 of the device's pivot hinges 33. The device 23 pivot hinges 33 are machined to an extremely close tolerance, effectively allowing only opening and closing movements and minimizing any play or wiggle in other directions.

FIG. 2 is a drawing of the basic device 23 in the open position, ready to have the device's 23 flat planar bottom surface 38 lined up with the predetermined precisely measured hoof wall 41 marks made by the farrier, showing how much hoof wall 48 should be trimmed off the foot 41 to leave it in perfect balance. In this FIG. 2 drawing of the device 23, the high tension heel strap 34 is not shown.

All horse owners, trainers and farriers should keep a written record of all measurements of all four feet of each horse in their care.

The following three measurements need to be correct to have the horse's foot in perfect balance: first—the length of toe, from the coronary band 45 down to ground surface 46; second—the heel length (both sides equal) from the coronary band 43 down to ground surface 44; and third—the angle of toe wall 47 in relation to ground surface. However, like a right angle triangle, if you know two of the measurements, the third is a geometric absolute, so it is with this device 23. If the flat planar bottom 38 of the device 23 is lined up with the mark at length of toe 46 and both marks at length of heels 44, then the angle of toe 47 is an automatic geometrically-correct absolute.

FIG. 3 is a drawing of the basic device 23 in the position attached and locked on firmly to the horse's foot 41 ready for the farrier to trim off the excess hoof wall 48. The coronary band of the horse's foot 41 is shown at reference characters 42, 43 & 45. In this drawing, the farrier has already measured the length of toe 46 from the coronary band 45 down to the desired ground level 46 of the hoof and has marked the hoof wall with a toe marking at this point, and he has also measured both heels from the coronary band 43 down to the desired ground level of the hoof at 44 and has marked them likewise with heel markings. He has then taken the device 23 and lined up the flat planar bottom 38 of the device 23 even with his precisely pre-measured hoof marks, then attached the device 23 firmly in place around the foot 41. The foot is now ready for the farrier to trim off the excess hoof wall 48 flush, even and level with the planar flat bottom 38 of the device 23, thereby leaving this horse's foot 41 in perfect balance.

The structure of the illustrated device is now described in more detail as follows. Referring to FIG. 1, the components making up the horse-shoe shape of the device 23 when in a closed condition are three curved links connected end to end with one another by the hinge or pivot joints, and more specifically include a central link 24 having an arcuate shape spanning approximately 180 degrees and two shorter extension links 25 connected to the central link 24 at opposite ends thereof. A top surface 24a of the central link 24 is coplanar with the top surface 25a of each extension link, just as a bottom surface 24b of the central link opposite the top surface 24a thereof is coplanar with bottom surfaces 25b of the extension links 25. Facing into the space between the ends of the central link is an inner side edge 24c of this link interconnecting the planar top and bottom surfaces thereof along a concavely arcuate path. The corresponding inner side edges 25c of the extension links 25 are likewise concavely curved. The concavely curved inner edge of each link is used to generally conform to or follow the curved shape of a hoofs front end to allow it to curve around the front toe end of the hoof to extend rearward along opposite sides thereof. In the illustrated embodiments, the outer side edge of the 24d, 25d of each link is arcuate about a same radial center as the opposing inner edge of that link to provide uniform width of the over its length while avoiding awkward shaping, excessive weight or bulkiness of the link, but it will be appreciated that the outer edge may vary in shape since it need not conform in any way to a hoof or other object in use.

The holding pins 31 project from the inner side edges of the links to present sharp pointed tip ends for engaging the hoof when placed thereagainst. Holding pins may be provided by feeding nails point-first into bores machined through the links from outer edge to inner edge. The bores may be stepped in diameter from a larger diameter at the outer side edge to a smaller diameter moving inward therefrom so that the shoulder defined at the transition from the larger diameter to the smaller diameter provides a stop against which the head of the nail is disposed when fed into the bore. The larger diameter portion of the bore may be tapped to receive a set screw to be threaded thereinto and tightened against the head of the nail to secure the nail in place with the nail head against the stop-defining change in the bore diameter.

The axes of the two hinges are parallel to one another and are each perpendicular to the common plane of the flat bottom surfaces of the links so that the relative movement between the links effectively occurs only along this plane. With reference to FIGS. 1 and 2, the bottoms surfaces of the extension links 25 thus act as extensions to the longer bottom surface of the central link 24 that can be swung through different angular orientations relative thereto in the plane thereof. The illustrated hinges are lap joint pivots of a structure similar to that commonly employed in fixed-pivot pliers, and thus well known to those skilled in the art of manually actuated tools. This known pivot joint between adjacent links at the ends thereof allows the necessary rotational motion between the links without having any elements of this hinged connection project beyond the flat bottom surfaces of the links, thereby maintaining a fully planar flat bottom over the full span of the tool. Other pivotal connections capable of maintaining this flat condition of the device's bottom face may alternatively be employed.

The pivoting of the extension links 25 allows movement of the two toward and away from another, and thus toward and away from the space between the ends of the central link, to control the size of the distance between the free ends 25e of the extension links. Accordingly, this gap between the free ends that defines the access way for receipt of the front of the hoof into the space embraced by the central link can be enlarged by pivoting the extension links outwardly away from one another.

With reference to FIG. 2, in an open position where the extension links have been sufficiently pivoted apart to lie entirely outward from the space between the ends of the central link, the device can accommodate a hoof having a width up to this distance between the hinges at these ends of the central link 24. On hooves smaller than this distance, the holding pins placed proximate the center of the central link on opposite sides of this center will still engage the front of the hoof even though a notable gap may be left between the sides of the hoof and the device at the hinges. The extension links are then moved back toward the closed position of FIG. 1 to embrace about the rear of the hoof's side. This placement and closing of the device onto the hoof is done with the coplanar bottom surfaces of the links visually aligned with the measured markings on the hoof, i.e. aligning the planar bottom surface of the central link 24 with the toe marking made to show the desired toe length at the front of the hoof, and aligning the planar bottom surface of each extension link 25 with the heel marking on the respective side of the rear of the hoof.

Manually held in place in this position with one hand, and with a small hammer in the other hand, the device is lightly tapped at the toe of front outside surface 24d of the device, thereby driving the two front pins 31 into the hoof wall until the inside bottom front center edge 24c butts up tight against the toe of the hoof wall. Then both extensions 25 are tapped with the hammer on their outside surface 25d driving the holding pins of the extensions into the hoof wall until the inside bottom edge 25c butts up tight against the hoof wall. Then the strap 34 is pulled taught across the heels at the rear of the hoof to more firmly dig the holding pins 31 on the central and extension links into the hoof, thereby securing the device thereto in the carefully placed position thereagainst aligned with the measurement markings. Pulled tight to provide sufficient tension, a one of the multiple attachment points defined by the series of holes 37 spaced apart along the strap 34 from proximate the end thereof opposite the strap's fixed end anchored atop one of the extension links by fastener 35 is aligned over the retaining point provided by the holding pin 36 projecting perpendicularly upward from the top of the other extension link. Although the fastener 35 is illustrated as a screw threaded into engagement with a feature at the top surface of the link, other fastening arrangements may be employed. For example, a bolt may be passed through a bore extending through the top and bottom surfaces of the link from beneath the link to pass through the strap and receive a lock nut thereover to clamp the strap in place, the head of the bolt being countersunk into the bottom surface of the link so as not to project past the plane of the intact remainder of the bottom surface of the link.

Placement of the strap hole 37 over the pin 36 completes the closure of the device fully around the hoof in the position aligned with the markings, which maintains the holding pins 31 in place in shallow-piercing engagement with the hoof. Use of releasable fastener, whether threaded or otherwise, to mount the strap on the device allows replacement of the strap should it break or become excessively worn. The hoof can then be raised from the ground on which it stood during placement of the device to access the bottom of the hoof wall. Hoof material is then trimmed away to the plane at which the bottom surfaces of the links rest while secured to the hoof so that the new resulting bottom of the hoof wall is flat and is situated at the measured and marked toe length, heel length and toe angle.

Once this trimming template device is attached to the hoof, it will not move, or fall off if the horse moves or even takes several steps.

In the illustrated embodiments, the bottom surface of each link is flat over its full width from the inner side edge to the outer side edge so that the entire bottom of the tool lies in the same common plane so that trimming or cutting tools passed over the device during trimming of the hoof have the maximum available surface area over which to contact the device to align the tool in desired cutting plane. At minimum, the intersection of the bottom surface of each link with the inner side edge thereof preferably marks the lowest extent of the tool since this boundary marks the part of the bottom surface that lies nearest the hoof when the device is used. Having further outward portions of the bottom surface lower than this inner boundary would potentially interfere with motion of trimming tools along the desired cutting plane, while having this inner boundary higher than outward coplanar portions defining a trimming guide plane would risk trimming tools possibly digging into the bottom of the hoof past the desired trimming plane, and so a completely flat bottom is most preferable.

As an example, the “Basic Trimming Template” of the first embodiment can be used with a ruler and a marker as follows.

Step One—Clean hoof and trim sole, bars and frog as per normal trim.
Step Two—Measuring down from the coronary band at the center of the toe and at both heels, mark the hoof wall at the precise measurements required for this foot.
Step Three—Attach the device around the hoof wall, with the bottom flat surface lined up on all three hoof measurements. Make sure the holding pins have penetrated the hoof wall and that the high tension heel strap has been pulled or stretched into place, thereby having the device attached firmly to the foot
Step Four—Pick up the foot so the ground surface is facing up, then remove (cut, nip, file or rasp) the excess hoof wall 48 until it is even, flush and in line with the bottom flat surface 38 of this template device.
Step Five—Remove the device from the foot. This foot has now been trimmed into balance and is ready for a shoe.

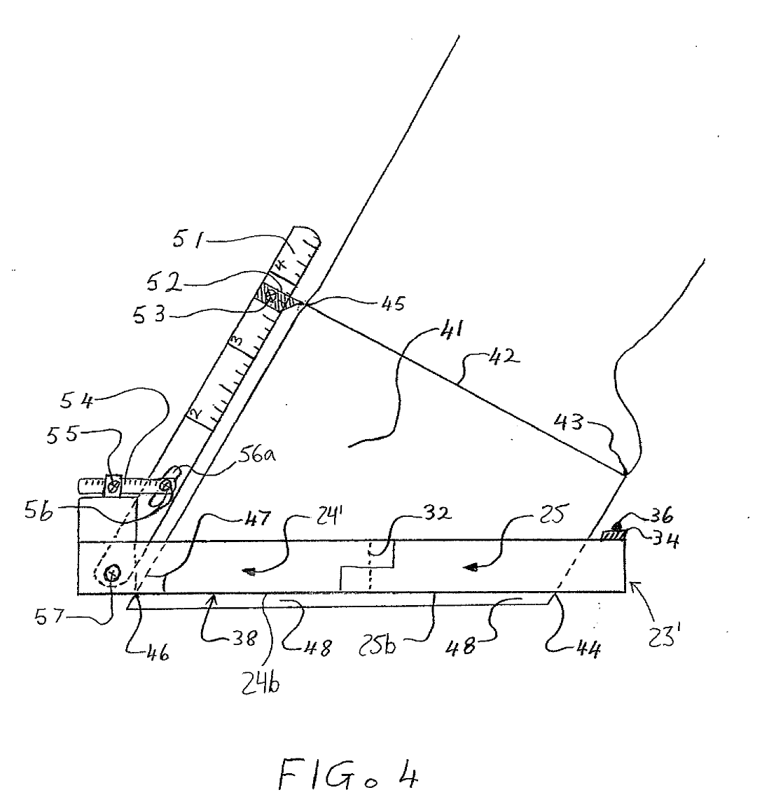

FIG. 4. is a drawing of a second embodiment device 23′ in the position attached and locked on firmly to the horse's foot 41 ready for the farrier to trim off the excess hoof wall 48.

The second embodiment device differs from the first in that a hoof gauge 51-57 has been added to the basic first embodiment device 23.

In FIG. 4 drawing it shows the hoof gauge including measurement indicia going up to 4½ inches of toe length, which is more than adequate for a large riding horse; big draft horses would require bigger devices 23 and bigger gauges 51-57.

The length of toe gauge features a measuring arm 51 with a sliding unit 52 slidably carried thereon for selective displacement along the measuring arm. This sliding unit 52 has a locking set screw 53 on it. This allows the farrier to pre-set and lock-in the desired length of toe to be measured from the coronary band 45 down the front of the hoof wall to mark the level to which the hoof should be trimmed at the toe. Markings or indicia on the measuring arm provide indication of the distance from proximate the plane of the bottom surfaces of the links to different points along the arm's length. Using FIG. 4 as an example, locking the slide unit at a position aligning an upper end thereof with a distance marker reflective of 3⅞ inches positions the upper end of the pointer at approximately this distance from the common plane of the links' bottom surfaces so that placement of an indicating or pointing end of the slide unit projecting rearward from the measuring arm against the coronary band of the animal hoof situates the bottom 38 of the device 3⅞ inches downward from the coronary band along the toe.

The measuring arm of the length of toe gauge 51 is also a component of an angle of toe gauge 54-57.

The measuring arm 51 has an angle gauge pivot 57 adjacent its lower end where the measuring arm is carried on the central link 24′ in a manner pivotal about an axis that is parallel to the plane of the bottom 38 of the device and parallel to a tangent of the central link's arcuate shape at a central point therealong. The distance markings or indicia on the measuring arm 51 mark distances from the bottom end of the arm 51 at or near the plane of the device's flat bottom 38. The measuring arm's pivot 57 is provided by a screw or bolt residing in a tangential bore through the central link 24′, the central link 24′ featuring a slot extending radially into its inner side edge at the link's plane of symmetry. This slot extends over the full height or thickness of the link, but not fully through its width, leaving an intact portion of the link's arcuate shape at its outer side edge to maintain a unitary structure of the link. The measuring arm 51 has its lower end received in this slot, with a hole through the arm aligning with the tangential bore passing through the slot so that the pivot screw 57 passes through the measuring arm to pivotally carry it on the central link 24′ for pivotal motion in the link's plane of symmetry. While location of the measuring arm's pivot axis at the plane of the flat bottom surfaces of the links would ensure complete accuracy of the length of toe marked by the sliding unit regardless of the arm's angular position, the illustrated position of the pivot axis a short distance above the plane of the device's flat bottom face prevents the measuring arm and pivot shaft thereof from projecting downward past this plane during the arm's useful range of motion so as not to interfere with movement of a trimming tool along this plane. The allowable range of motion of the arm preferably accommodates angles at least between forty and sixty degrees relative to the flat bottom face of the device, which is suitable for this use.

There is a sliding angle of hoof gauge indicator 54 with a sliding and locking angle gauge pivot 56 and an angle of hoof gauge locking set screw 55. The angle gauges slide arm 54 is carried in a position over the central link 24′ atop a support block secured on the top surface thereof, and is linearly slidable in a plane parallel to the central link's plane of symmetry along an axis parallel to the device's flat bottom surfaces 38. A guide through which the slide arm 54 moves limits this motion to linear displacement and carries the set screw 55 that can be tightened against the slide arm 54 through a lateral side of the guide to clamp the slide arm 54 against the opposite side of the guide to selectively lock the slide arm in place. The sliding and locking pivot 56 is carried at an end of the slide arm 54 on a rear side of the guide corresponding to the inside of the curved central link 24′. The sliding and locking pivot 56 features a screw threaded through the slide arm 54 in a direction perpendicular to the plane thereof and passing through a slot 56a extending along the measuring arm 51. The end of the sliding pivot screw 56 on the side of the measuring arm 51 opposite the sliding arm 54 carries a stop element of greater diameter than the screw shaft and greater width than the slot 56a so that rotation of the sliding screw in one direction will draw the stop element tighter against the measuring arm 51 to clamp it against the sliding arm 54 in a stationary position to lock the measuring arm in place.

When the sliding pivot screw 56 is loosened off of the measuring arm 51 and the set screw 55 is loosened off the sliding arm 54, the measuring arm 51 and sliding arm 54 are free to pivot and slide respectively, with the slot 56a allowing relative motion between the two arms during adjustment of the measuring arm's angle about its pivot end 57 relative to the plane of the device's flat bottom 38 The sliding arm 54 features angle markings or indicia at spaced positions along it for use in reading this angle of the measuring arm 51 to allow selective locking thereof into a desired toe angle for the hoof to be trimmed. Alternatively, the angle markings may be displayed on a piece separate from the slide arm 54 and fixed in position relative to the central link and support block thereon to simplify the angle marking scale or improve its accuracy since motion of the measuring arm would then be purely pivotal relative to the component on which the angle markings are defined.

It will be appreciated that a hoof gauge configuration other than that detailed above may alternatively be mounted on a template device of the present invention, and may possibly be mounted thereon in a removable manner to allow separation of the measuring arm, and possibly other gauge components assembled therewith, from the rest of the device in order to allow collapse of the two or more piece device into a disassembled condition for compact, space efficient storage or transport. As one possible example, a hoof gauge may be removably mountable atop the central link by use of cooperating male and female elements on opposing ones of the central links and a support base of the detachable gauge assembly to align the gauge in proper position relative to the link (e.g. projecting post or pin-like protuberances on the bottom of the gauge block insertable into holes or recesses in the top surface of the central pin) and use of one or more magnets to magnetically secure the gauge assembly atop the link in this received position. In such an embodiment, where the pivot axis of the arm may be on the support block atop the central link, therefore well above the planar bottom of the device, the toe length indicia would not measure only to the end of the measuring arm, but rather down to a point lying at the plane of the device's flat bottom with the arm at an angle within the angular range commonly required for most horses.

With this hoof gauge 51-57 incorporated into the device 23′, it eliminates the need or use of any other type of hoof gauge normally used by the farrier and the farrier does not have to take the time to measure and mark each hoof individually, thereby saving him more time. Simply by looking at the recorded records of the required measurements of this particular horse's foot, the farrier presets and locks in the length of toe gauge 52 with the locking set screw 53. Then, he adjusts the sliding angle of the hoof gauge indicator 54 to the required angle. Then, he locks it in with the angle of hoof gauge locking screws 55 and 56.

The device 23′ is now ready to be attached to the horse's foot 41 with the sliding unit 52 of the hoof gauge aligned with the coronary band at the front toe end of the hoof. Having had the toe length and angle pre-set, this automatically positions in the planar bottom of the device at the appropriate position to define a guide for trimming off the excess hoof wall 48 flush, even and level with the level flat bottom 38 of the device 23′, thereby leaving this horse's foot 41 in effectively perfect balance. Because length of toe 45 to 46 was pre-set and locked in on the toe gauge 51 and the angle of the toe 47 was preset and locked-in on the angle gauge 54, the length of heels 43 to 44 is automatically a geometrically correct measurement to same degree as the angle and length of toe. Horses' feet 41 are always matched in pairs to look as identical as possible, therefore, the two back feet are trimmed the same, and the two front feet are trimmed the same. When this device 23′ with gauge 51-57 is removed from the foot 41 leaving it effectively level and balanced, without doing any adjustments to it, this device is ready to be attached to the matching foot of this horse, thereby trimming the second foot into a match of the first one. This will save the farrier even more time and make his finished work look very professional.

As an example, the “Trimming Template” with “Attached Hoof Gauge” of the second embodiment may be used as follows:

Step One—Clean hoof and trim sole, bars and frog as per normal trim.
Step Two—Set sliding toe gauge indicator 52 at setting required for this foot then lock it in place with the locking set screw 53.
Step Three—Set sliding angle of hoof gauge indicator 54 at precise toe angle required for this foot, then lock it in place with the locking screws 55 and 56.
Step Four—Attach the device around the hoof wall with the length of toe gauge set at the coronary band at the precise length of toe required for this foot, then securely fasten device firmly to hoof wall.
Step Five—Pick up foot so the ground surface thereof is facing up, then remove (cut, nip, file or rasp) the excess hoof wall 48 until it is even, and in line with the bottom flat surface 38 of this template device.
Step Six—Remove the device from the foot. This foot has now been trimmed into balance and is ready for a shoe.
Note: This device still has the length of toe and the angle set and locked, and is ready for “Step Four” on the matching foot of this horse. This will save the farrier more valuable time, and ensure that when the second foot is finished, it will be a dimensional match of the one beside it.

An improved farrier device of the present invention will guide the farrier's cutting tools to trim off of the hoof wall of the equine animal the predetermined and measured amount to aid in striving for perfect balance of the horse's foot every time.

Preferably made of tool hardened steel or other hard rigid material, the device will give many years of durable service.

The device of each illustrated embodiment encircles the horse's foot and clamps and attaches solidly to the exterior hoof wall at predetermined and effectively precise measurements. Then it stays attached on the foot, while it guides the farrier's cutting tools in trimming off the excess hoof wall flush, even, and level with the flat, planar bottom of this device, thereby leaving the foot in perfect balance every time.

The devices can be made in different sizes to accommodate the different sizes of equine feet, from the smallest pony to the largest draft horse. The larger size devices may be made heavier and stronger, possibly with additional intermediate links between the front-central link and the end links defining the free ends of the device through which the hoof is accepted during placement. Such additional links would have corresponding extra pivot hinges establishing their pivotal end connections to the other links, as well as extra penetrating holding pins. In other larger embodiments, a three-link structure could instead be retained simply by enlarging at least the central link, preferably all three links, and possibly adding additional holding pins.

This device could be held in place on the hoof wall of the horse's foot in many different ways, but this would not change the basic purpose, or outcome of what this device does in any way. Examples of other ways of holding this device to the hoof wall of the horse's foot include nails, screws, straps, belts, buckles, velcro, elastic, clips, serrated edges, glue, holding by hand, combinations thereof, etc.

A horse's foot in perfect balance on a level ground surface has to have the following 3 precise measurements: #1—the length of toe from the coronary band at the center of the foot down to ground surface; #2—the length of heels (both sides identical) from the coronary band down to ground surface; and #3—the angle of toe off the horizontal level ground surface at the center of the foot.

When the first embodiment “Basic Trimming Template” device is set and locked on to the foot at the desired toe length (#1) and at the desired length of heels (#2), then the resulting toe angle (#3) is automatically accurate and geometrically correct.

When the second embodiment “Trimming Template with Attached Hoof Gauge” device is set and locked on to the foot at the desired length of toe (#1) and at the desired angle of toe (#3), then the desired length of heels (#2) is automatically accurate and geometrically correct relative to the selected toe length and angle.

Each of the unique Equine Trimming Template devices illustrated completely encircles the horse's hoof wall, then locks solidly into place at predetermined and effectively precise measurements for each foot of each individual horse. It then stays attached to the horse's foot while the farrier's trimming tools are guided by it, to perform a quick and effectively accurate job, leaving the foot reliably trimmed into effectively perfect balance.

Farriers are skilled tradesmen, but they are also running a very professional proprietor owned business. The success or failure of their business is dependent on how many horses they shoe per day and how pleased their customers are. In the farrier's working day, theoretical knowledge needs to be able to be easily transposed to working knowledge. In a world where time is money, farriers need to be able to shoe a number of horses per day using a reliable method to produce a predictable and satisfactory outcome for both horse and owner. The number of times the hoof is picked up needs to be minimized, the accuracy of achieving a correct hoof/pastern angle (front to back balance) and correct medial/lateral angle (side to side balance) needs to be increased and the ability to duplicate a time efficient method of achieving this effectively perfect balance every time also needs to be increased. With existing systems, all the vast technical knowledge available is often not helping farriers in the field.

Every horse owner/trainer, should keep a written record of all four feet of each horse in their care, showing all measurements and angles of each foot. This record should be available to the farrier before he starts trimming the horse's foot. Farriers are business people and therefore should also keep precise balance records of each horse that is part of their business.

If this quick, efficient and easy to use “Equine Trimming Template” device is positioned and attached properly to the hoof wall, it will guide the farrier's tools so the only possible outcome will result in a balanced foot every time without fail.

This balanced foot with its flat ground surface, will also eliminate the need for hot-shoeing as there will not be any high spots to burn off for a better fitting of the shoe. This will make the farrier's job easier and will save him a lot of time on each horse. Another benefit will be that it will help the horse that has contracted heels due to dryness.

Even novice farriers just beginning their career will be able to trim a horse's foot into effective balance every time with the use of this quick, efficient and easy to use device.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. A template device for use in trimming an animal hoof, the device comprising a series of links hingedly connected end to end by pivotal connections about parallel axes, two end links in the series having free ends opposite the pivotal connections of the two end links to one or more other links therebetween, the free ends of the end links defining opposite ends of the series of links, the series of links being pivotal relative to one another into and out of a horseshoe-shaped configuration in which corresponding side edges of the series of links are positioned end-to-end along a curved path to enable positioning of the links about the animal hoof, bottom surfaces of the series of links lying in a same common plane to form a guide for trimming of the bottom of the hoof when the series of links is held stationary against the hoof.

2. The template device of claim 1 wherein the corresponding side edges of the series of links are curved concavely therealong.

3. The template device of claim 1 comprising hoof engagement elements at the corresponding side edges to grip the animal hoof when placed thereagainst.

4. The template device of claim 3 wherein each hoof engagement element comprises a pointed end pointing away from a remainder of a corresponding link on which the hoof engagement element is carried.

5. The template device of claim 4 wherein the hoof engagement elements comprise pins projecting from the corresponding sides of the series of links at spaced positions along the series of links.

6. The template device of claim 1 comprising a fastener operable to secure the series of links in place on the hoof of the animal.

7. The template device of claim 1 comprising a fastener operable to interconnect the end links to form a closure of the series of links around the animal hoof.

8. The template device of claim 7 wherein the fastener is operable to interconnect the ends links with varying distances between the free ends of the end links corresponding to varying sizes of the horseshoe-shaped configuration.

9. The template device of claim 7 wherein the fastener comprises a strap fixed to a first of the two end links proximate a first end of the strap.

10. The template device of claim 9 wherein the strap comprises a series of attachment points spaced therealong proximate a second end of the strap opposite the first, each attachment point being selectively and removably engageable to a retaining point on a second of the two end links.

11. The template device of claim 1 comprising a hoof gauge carried on a respective link of the series of links, the hoof gauge comprising a measuring arm pivotal relative to the respective link about an axis extending therealong parallel to the common plane and at least one indicator arranged to convey one or both of an angle at which the measuring arm is disposed relative to the common plane and a length from proximate common plane to different positions along the measuring arm.

12. The template device of claim 11 comprising a locking mechanism arranged to selectively lock an angular position of the measure arm about the axis.

13. The template device of claim 11 wherein the at least one indicator comprises a length indicator featuring a series of distance markings spaced along the measuring arm and a slide unit displaceable along the measuring arm and releaseably lockable at any selected position therealong indicating a respective one of the distance markings.

14. The template device of claim 1 wherein the series of links comprises a central link that is concavely curved along the corresponding side thereof, the concavely curved corresponding side spanning approximately 180 degrees.

15. The template device of claim 14 wherein the series of links consists of the central link and the two end links.

16. A template device for use in trimming an animal hoof, the device comprising:
a central link having top and bottom surfaces facing opposite directions and a concave inner edge interconnecting the top and bottom surfaces along curved inner sides thereof to enable placement of the central link adjacent the front of the animal hoof in a position curving thereabout to extend rearwardly about the animal hoof on opposite sides thereof;
first and second extension links having hinged connections to central link adjacent respective opposing ends of the concave inner edge to facilitate pivoting of the first and second extension links about parallel axes that extend in directions passing through the top and bottom surface of the central link, the extension links being pivotal toward and away from one another and the concave inner edge of the central link to adjust a distance between ends of the extension links opposite the central link to accommodate differently sized hooves between the extension links during the placement of the central link thereon, and
hoof engagement elements provided at the concave inner edge of the central link to grip the front of the animal hoof when placed thereagainst to resist movement relative thereto;
the extension links having respective lower surfaces lying in a same common plane as the bottom surface of the central link to effectively provide extensions thereof past the respective end of the concave inner edge of the central link, the bottom surface and the extensions thereof providing a guide for trimming of the animal hoof along the common plane in which the bottom surface and the extensions thereof lie when the device is held in place against the animal hoof with central link curving from the front thereof and the extension links closed toward one another rearwardly around the hoof from the central link.

17. A method of trimming a hoof of an animal comprising:
temporarily securing a template device, having guide surfaces disposed within a common plane of the device, to the hoof in a position extending about the periphery of the hoof with the guide surfaces positioned adjacent the hoof in a trimming plane corresponding to a selected combination of toe length, toe angle and heel length;
with the template device secured to the hoof, trimming away hoof material from a bottom of the hoof wall up to the common plane in which the guiding surfaces lie to produce a resulting flat bottom of the hoof wall that occupies the trimming plane; and
removing the template device from the hoof.

18. The method of claim 17 wherein the template device is temporarily secured to the hoof while the hoof is standing on a surface that is not any part of the template device.

19. The method of claim 17 comprising first marking a periphery of the hoof with a toe marking proximate a front of the hoof and heel markings proximate a rear of the hoof on opposite sides thereof; then temporarily securing the template device to the hoof with the guide surfaces aligned with the toe and heel markings on the hoof.

20. The method of claim 17 comprising first using a hoof gauge on the device to measure out the toe length and toe angle of the selected combination on the hoof, and then securing the device to the hoof in a position at which the hoof gauge measures out said toe length and toe angle and the guide surfaces are accordingly positioned in the trimming plane.
